(19) United States
(12) Patent Application Publication
(10) Pub. No.: US 2025/0148756 A1
(43) Pub. Date: May 8, 2025

(54) CLASSIFICATION APPARATUS, CLASSIFICATION METHOD, AND NON-TRANSITORY COMPUTER-READABLE MEDIUM

(71) Applicant: NEC Corporation, Minato- ku, Tokyo (JP)

(72) Inventor: Kenta lshihara, Tokyo (JP)

(73) Assignee: NEC Corporation, Minato- ku, Tokyo (JP)

(21) Appl. No.: 18/833,505

(22) PCT Filed: Feb. 9, 2022
(86) PCT No.: PCT/JP2022/005138

§ 371 Date: Jul. 26, 2024

(51) Int. Cl. G06V 10/764; G06V 10/72; G06V 10/77; G06V 40/20

(52) U.S. Cl. CPC G06V 10/764; G06V 10/72; G06V 10/7715; G06V 40/20

(57) ABSTRACT

A classification apparatus acquires first input data being a first type of feature value and second input data being a second type of feature value for a classification target. The classification apparatus computes a first intermediate feature value from first input data, and computes a second intermediate feature value from second input data. The classification apparatus computes first attention data from the second intermediate feature value, and computes second attention data from the first intermediate feature value. The classification apparatus computes a first feature value from the first intermediate feature value and the first attention data, and computes a second feature value from the second intermediate feature value and the second attention data. The classification apparatus performs classification for a classification target by using the first feature value, the second feature value, or both of the first feature value and the second feature value.

### TECHNICAL FIELD

The present disclosure relates to classification.

### BACKGROUND ART

Techniques for identifying a class to which data belongs have been developed. For example, Non Patent Literature 1 discloses a technique for identifying a type of a motion performed by a person by using an image feature value obtained from each video frame and a skeleton feature value of the person detected from each video frame, for video data in which the motion of the person is recorded. Non Patent Literature 1 roughly discloses two types of methods. The first method is a method of identifying a motion by inputting data obtained by linking an image feature value and a skeleton feature value to a classification model. The second method is a method of identifying a motion by inputting an image feature value and a skeleton feature value to the respective classification models and integrating the outputs from the two classification models.

### CITATION LIST

### Non Patent Literature

Non Patent Literature 1: T. Kobayashi, Y. Aoki, S. Shimizu, K. Kusano, and S. Okumura, “Fine-Grained Action Recognition in Assembly Work Scenes by Drawing Attention to the Hands”, Proceedings of International Conference on Signal-Image Technology & Internet-Based Systems (SITIS), pp. 440-446, 2019

### SUMMARY OF INVENTION

### Technical Problem

In Non Patent Literature 1, two feature values input to the classification models are independently generated. The present disclosure has been made in view of this problem, and an object of the present disclosure is to provide a new method for classification.

### Solution to Problem

According to the present disclosure, a classification apparatus includes acquisition means for acquiring, for a classification target, first data being a first type of feature value and second data being a second type of feature value; first feature extraction means for computing a first intermediate feature value from the first data, and then further computing a first feature value by using the first intermediate feature value; second feature extraction means for computing a second intermediate feature value from the second data, and then further computing a second feature value by using the second intermediate feature value; classification means for performing classification regarding the classification target by using the first feature value, the second feature value, or both thereof; and attention data generation means for computing first attention data by using the second intermediate feature value and computing second attention data by using the first intermediate feature value.

The first feature extraction means computes the first feature value by using the first intermediate feature value and the first attention data.

The second feature extraction means computes the second feature value by using the second intermediate feature value and the second attention data.

According to the present disclosure, a classification method is executed by a computer. The method includes an acquisition step for acquiring, for a classification target, first data being a first type of feature value and second data being a second type of feature value; a first feature extraction step for computing a first intermediate feature value from the first data and then further computing a first feature value by using the first intermediate feature value; a second feature extraction step for computing a second intermediate feature value from the second data and then further computing a second feature value by using the second intermediate feature value; a classification step for performing classification regarding the classification target by using the first feature value, the second feature value, or both thereof; and an attention data generation step for computing first attention data by using the second intermediate feature value and computing second attention data by using the first intermediate feature value.

In the first feature extraction step, computing the first feature value by using the first intermediate feature value and the first attention data.

In the second feature extraction step, computing the second feature value by using the second intermediate feature value and the second attention data.

According to the present disclosure, a non-transitory computer-readable medium stores a program for causing a computer to execute the classification method of the present disclosure.

### Advantageous Effects of Invention

According to the present disclosure, it is possible to provide a new method for classification.

### BRIEF DESCRIPTION OF DRAWINGS

FIG. 1 is a diagram illustrating an overview of an operation of a classification apparatus according to an example embodiment.

FIG. 2 is a block diagram illustrating a functional configuration of the classification apparatus.

FIG. 3 is a block diagram illustrating a hardware configuration of a computer that implements the classification apparatus.

FIG. 4 is a flowchart illustrating a flow of processing performed by the classification apparatus.

FIG. 5 is a diagram illustrating a feature extraction model and an attention model.

FIG. 6 is a first diagram illustrating a configuration of an attention generation model.

FIG. 7 is a second diagram illustrating the configuration of the attention generation model.

FIG. 8 is a diagram illustrating a case where an intermediate feature value and attention data are generated a plurality of times.

### EXAMPLE EMBODIMENT

Hereinafter, an example embodiment of the present disclosure is described in detail with reference to the drawings. In the drawings, the same or corresponding elements are denoted by the same reference numerals, and repeated description is omitted as necessary for clarity of description. In addition, unless otherwise described, predetermined values such as predetermined values and thresholds are stored in advance in a storage device or the like accessible from an apparatus using the values. Furthermore, unless otherwise described, a storage unit includes one or any larger number of storage devices.

### <Overview>

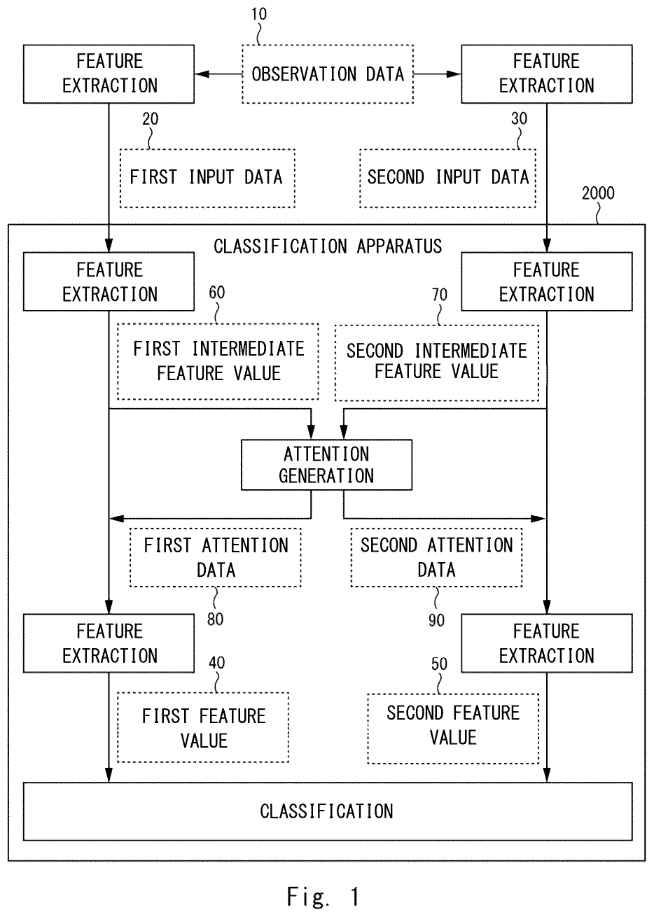

FIG. 1 is a diagram illustrating an overview of an operation of a classification apparatus 2000 according to an example embodiment. Here, FIG. 1 is a diagram for facilitating understanding of the overview of the classification apparatus 2000, and the operation of the classification apparatus 2000 is not limited to that illustrated in FIG. 1.

The classification apparatus 2000 performs a process of identifying a class regarding a classification target. For example, the classification target is any object. The object may be a person or another animal, may be an organism (such as a plant) other than an animal, or may be an inanimate object. In addition, the classification target is not limited to one object, and may be a plurality of objects. In addition, the classification target is not limited to an object. For example, the classification target may be a scene constituted by an object and the background thereof.

The class regarding the classification target may represent the type of the classification target itself, or may represent other types regarding the classification target. In the latter case, for example, the class represents the type of a motion or a state of the classification target.

The classification apparatus 2000 performs classification for the classification target by using a plurality of different types of data obtained for the classification target. The data acquired by the classification apparatus 2000 includes at least first input data 20 that is a first type of data and second input data 30 that is a second type of data. In order to simplify the description, first, a case where the classification apparatus 2000 acquires two types of data (that is, the first input data 20 and the second input data 30) will be described. A case where the classification apparatus 2000 uses three or more types of data will be described later.

Both the first input data 20 and the second input data 30 are feature values extracted from observation data 10 obtained as a result of observation performed on the classification target. However, the first input data 20 and the second input data 30 are different types of feature values. Note that, in the present disclosure, the expression “extraction of a feature value” and the expression “computation of a feature value” are used in the same meaning as each other.

Here, the first input data 20 and the second input data 30 may be feature values extracted from the same observation data 10, or may be feature values extracted from different pieces of observation data 10. The former case is, for example, a case where an image feature value and a skeleton feature value extracted from image data are used as the first input data 20 and the second input data 30, respectively. On the other hand, the latter case is, for example, a case where the image feature value extracted from the image data is used as the first input data 20, and a sound feature value extracted from sound data is used as the second input data 30. Note that it is preferable that there is a temporal relationship between the observation data 10 from which the first input data 20 is extracted and the observation data 10 from which the second input data 30 is extracted. For example, it is preferable that the observation for obtaining the two pieces of observation data 10 is performed at substantially the same time point.

Examples of the type of observation data include image data (for example, an RGB image or a grayscale image) obtained by capturing a classification target, sound data obtained by recording sound around the classification target, distance data (for example, a depth image) obtained by measuring a distance to the classification target, and biological data (for example, heart rate data or brain wave data) obtained by recording biological information emitted from the classification target.

The observation data may be independent data that does not constitute time-series data, or may be frame data constituting time-series data. Examples of the independent data that does not constitute the time-series data include still image data generated by a still camera. Examples of the frame data constituting the time-series data include video frames constituting video data generated by a video camera.

Various feature values can be handled as the feature value obtained from the observation data. For example, data obtained by performing dimensional compression by a convolution process or the like on observation data can be handled as the feature value of the observation data. In another example, data obtained by executing a specific analysis process on observation data can be handled as the feature value of the observation data. For example, in a case where the observation data is image data, a skeleton feature value representing the position of a skeleton or optical flow data representing an optical flow of each pixel can be used as the feature value.

The position of the skeleton indicated by the skeleton feature value may be a two-dimensional position on the image or a three-dimensional position on a specific three-dimensional space. In addition, the skeleton feature value is not limited to data indicating the positions of joint points of an animal, and may be data indicating the positions of one or more joints included in a machine such as a robot as the positions of the joint points. Furthermore, the granularity of the skeleton represented by the skeleton feature value is set in accordance with the size of a person or the like included in the image data, the granularity of the behavior of a recognition target, and the like. For example, in a case where an arm and a hand of a person are largely captured in the image data, it is preferable that the skeleton feature value indicates a joint point of each of a plurality of joints of a finger. On the other hand, in a case where the entire body of a person is captured in the image data, for example, the skeleton feature value only needs to indicate joint points of a wrist joint as the joint point for the hand, and does not need to indicate the joint point of each joint of the finger.

The classification apparatus 2000 computes a first feature value 40 and a second feature value 50 from the first input data 20 and the second input data 30, respectively. Then, the classification apparatus 2000 determines a class regarding the classification target (identifies the class) by using the first feature value 40, the second feature value 50, or both thereof.

Here, the classification apparatus 2000 performs multi-stage feature extraction for each of the first input data 20 and the second input data 30. In FIG. 1, as a simple example, two-stage feature extraction is performed for each of the first input data 20 and the second input data 30. Specifically, a first intermediate feature value 60 is extracted from the first input data 20, and then the first feature value 40 is extracted from the first intermediate feature value 60. In addition, a second intermediate feature value 70 is extracted from the second input data 30, and then the second feature value 50 is extracted from the second intermediate feature value 70.

Here, not only the first input data 20 but also the second input data 30 is used to compute the first feature value 40. Specifically, the classification apparatus 2000 generates first attention data 80 by using the second intermediate feature value 70 computed from the second input data 30. Then, the classification apparatus 2000 computes the first feature value 40 by using the first intermediate feature value 60 and the first attention data 80. Note that the first intermediate feature value 60 may be further used to generate the first attention data 80.

Similarly, not only the second input data 30 but also the first input data 20 is used to compute the second feature value 50. Specifically, the classification apparatus 2000 generates second attention data 90 by using the first intermediate feature value 60 computed from the first input data 20. Then, the classification apparatus 2000 generates the second feature value 50 by using the second intermediate feature value 70 and the second attention data 90. Note that the second intermediate feature value 70 may be further used to generate the second attention data 90.

Here, when both of the first intermediate feature value 60 and the second intermediate feature value 70 are used to generate the attention data, one piece of attention data generated by using the first intermediate feature value 60 and the second intermediate feature value 70 may be used as both of the first attention data 80 and the second attention data 90.

### Example of Advantageous Effect

According to the classification apparatus 2000 of the present embodiment, the feature extraction is further performed for two types of feature values of the first input data 20 and the second input data 30, and the classification for the classification target is performed by using the first feature value 40, the second feature value 50, or both thereof. The first feature value 40 and the second feature value 50 are obtained as a result of the feature extraction. Here, the first feature value 40 is computed from data in which the first attention data 80 is applied to the first intermediate feature value 60 extracted from the first input data 20. The first attention data 80 is generated based on the second intermediate feature value 70 extracted from the second input data 30. As a result, the first feature value 40 is computed from data that is obtained by assigning weights represented by an intermediate feature value extracted from the second input data 30 to an intermediate feature value extracted from the first input data 20. Similarly, the second feature value 50 is computed from data that is obtained by assigning weights represented by the intermediate feature value extracted from the first input data 20 to the intermediate feature value extracted from the second input data 30. Therefore, according to the classification apparatus 2000, the feature value used for classification takes into consideration of the importance between the plurality of types of feature values. Thus, it is possible to perform classification for the classification target with higher accuracy.

Hereinafter, the classification apparatus 2000 of the present example embodiment will be described in more detail.

### Example of Functional Configuration

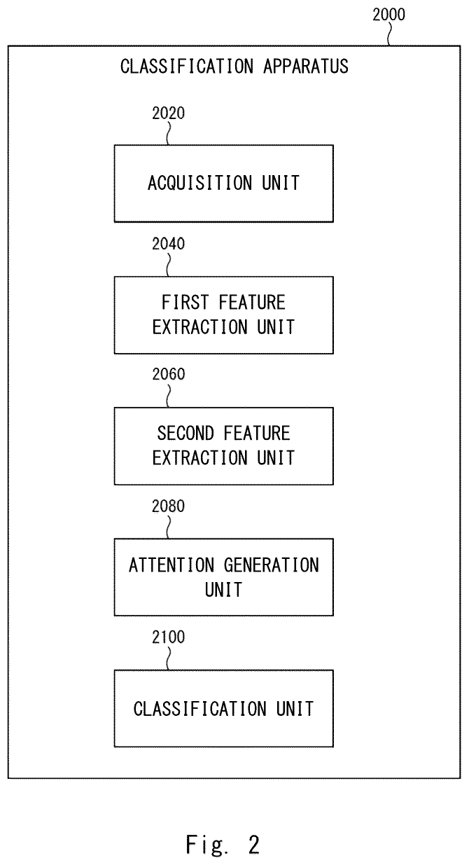

FIG. 2 is a block diagram illustrating a functional configuration of the classification apparatus 2000 of the example embodiment. The classification apparatus 2000 includes an acquisition unit 2020, a first feature extraction unit 2040, a second feature extraction unit 2060, an attention generation unit 2080, and a classification unit 2100. The acquisition unit 2020 acquires first input data 20 and second input data 30. The first feature extraction unit 2040 computes a first intermediate feature value 60 from the first input data 20. The second feature extraction unit 2060 computes a second intermediate feature value 70 from the second input data 30.

The attention generation unit 2080 computes second attention data 90 by using the first intermediate feature value 60. The attention generation unit 2080 computes first attention data 80 by using the second intermediate feature value 70.

The first feature extraction unit 2040 computes a first feature value 40 by using the first intermediate feature value 60 and the first attention data 80. The second feature extraction unit 2060 computes a second feature value 50 by using the second intermediate feature value 70 and the second attention data 90. The classification unit 2100 determines a class regarding the classification target by using the first feature value 40, the second feature value 50, or both thereof.

### Example of Hardware Configuration

Each functional configuration unit of the classification apparatus 2000 may be implemented by hardware (for example, a hard-wired electronic circuit or the like) that implements each functional configuration unit, or may be implemented by a combination of hardware and software (for example, a combination of an electronic circuit and a program that controls the electronic circuit or the like). Hereinafter, a case where each functional configuration unit of the classification apparatus 2000 is implemented by a combination of hardware and software will be further described.

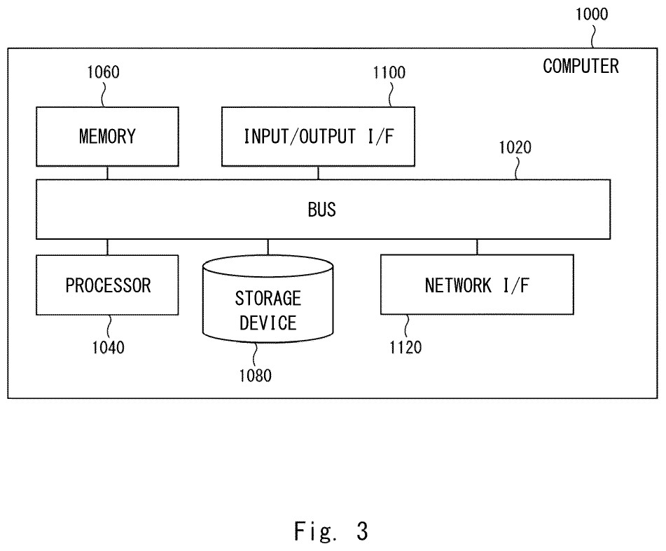

FIG. 3 is a block diagram illustrating a hardware configuration of a computer 1000 that implements the classification apparatus 2000. The computer 1000 is any computer. For example, the computer 1000 is a stationary computer such as a personal computer (PC) or a server machine. In another example, the computer 1000 is a portable computer such as a smartphone or a tablet terminal.

The computer 1000 may be a dedicated computer designed to implement the classification apparatus 2000, or may be a general-purpose computer.

For example, by installing a predetermined application in the computer 1000, each function of the classification apparatus 2000 is implemented in the computer 1000. The above-described application is configured with a program for implementing the functional configuration units of the classification apparatus 2000. Note that the method of acquiring the program is arbitrary. For example, the program can be acquired from a storage medium (a DVD disk, a USB memory, or the like) in which the program is stored. The program can also be acquired, for example, by downloading the program from a server device that manages the storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, the method of connecting the processor 1040 and the like to each other is not limited to the bus connection.

The processor 1040 is any of processors such as a central processing unit (CPU), a graphics processing unit (GPU), or a field-programmable gate array (FPGA). The memory 1060 is a primary storage device implemented by using a random access memory (RAM) or the like. The storage device 1080 is a secondary storage device implemented by using a hard disk, a solid state drive (SSD), a memory card, read only memory (ROM), or the like.

The input/output interface 1100 is an interface connecting the computer 1000 and an input/output device. For example, an input apparatus such as a keyboard and an output apparatus such as a display apparatus are connected to the input/output interface 1100.

The network interface 1120 is an interface connecting the computer 1000 to a network. The network may be a local area network (LAN) or a wide area network (WAN).

The storage device 1080 stores a program (program for implementing the above-described application) for implementing each functional configuration unit of the classification apparatus 2000. The processor 1040 reads the program to the memory 1060 and executes the program to implement each functional configuration unit of the classification apparatus 2000.

The classification apparatus 2000 may be implemented by one computer 1000 or may be implemented by a plurality of computers 1000. In the latter case, the configurations of the computers 1000 do not need to be the same, and can be different from each other.

### <Flow of Processing>

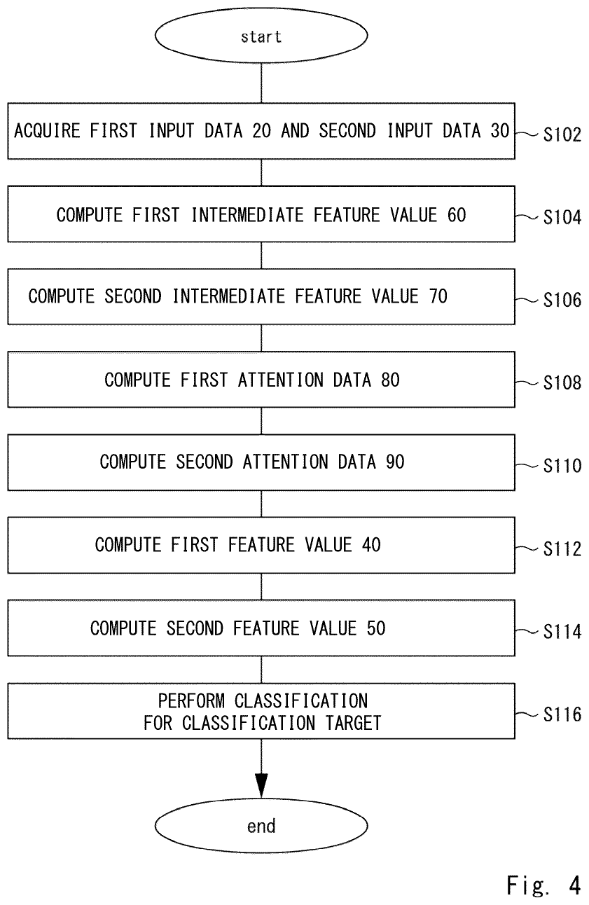

FIG. 4 is a flowchart illustrating a flow of processes performed by the classification apparatus 2000 of the example embodiment. The acquisition unit 2020 acquires the first input data 20 and the second input data 30 (S102). The first feature extraction unit 2040 computes a first intermediate feature value 60 from the first input data 20 (S104). The second feature extraction unit 2060 computes a second intermediate feature value 70 from the second input data 30 (S106).

The attention generation unit 2080 computes first attention data 80 from the second intermediate feature value 70 (S108). The attention generation unit 2080 computes second attention data 90 from the first attention data 80 (S110).

The first feature extraction unit 2040 computes a first feature value 40 from the first intermediate feature value 60 and the first attention data 80 (S112). The second feature extraction unit 2060 computes a second feature value 50 from the second intermediate feature value 70 and the second attention data 90 (S114).

The classification unit 2100 determines a class regarding the classification target by using the first feature value 40, the second feature value 50, or both thereof (S116).

Note that the flow of processes illustrated in FIG. 4 is an example, and the flow of processes performed by the classification apparatus 2000 is not limited to the flow illustrated in FIG. 4. For example, the computation of the first intermediate feature value 60 and the computation of the second intermediate feature value 70 may be performed in parallel, or may be performed in an order opposite to the order illustrated in FIG. 4. In another example, the computation of the first attention data 80 and the computation of the second attention data 90 may be performed in parallel, or may be performed in an order opposite to the order illustrated in FIG. 4. In another example, the computation of the first feature value 40 and the computation of the second feature value 50 may be performed in parallel, or may be performed in an order opposite to the order illustrated in FIG. 4.

### <Acquisition of First Input Data 20: S102>

The acquisition unit 2020 acquires the first input data 20 (S102). As described above, the first input data 20 is a feature value extracted from the observation data 10. Here, various methods can be used as the method of extracting the feature value from various pieces of observation data 10 described above. In a case where data obtained by performing dimensional compression on the observation data 10 is used as the first input data 20, for example, by inputting the observation data 10 to a neural network such as a convolutional neural network (CNN), the feature value of the observation data 10 can be extracted from a feature extraction layer of the CNN. In another example, in a case where data obtained by analyzing the observation data 10 is used as the first input data 20, the first input data 20 can be obtained by applying an analysis method capable of obtaining a desired type of data to the observation data 10. For example, it is assumed that the observation data 10 is image data, and a skeleton feature value obtained from the image data is used as the first input data 20. In this case, the skeleton feature value can be obtained by applying a skeleton extraction method, such as OpenPose, to the observation data 10.

Here, the first input data 20 may be a feature value extracted from a part of the observation data 10 instead of the entirety of the observation data 10. For example, it is assumed that the observation data 10 is image data and the classification target is a person. In this case, for example, the first input data 20 is generated by extracting the feature value only from an image region (a person region, hereinafter) representing the person in the observation data 10. Various methods can be used as a method of detecting the person region from the image data. For example, the person region can be detected by executing a person detection process on the image data.

Furthermore, as described above, the observation data 10 may be frame data constituting time-series data. In this case, the first input data 20 may be a feature value that is extracted taking into consideration not only the observation data 10 itself but also a time series represented by time-series data including the observation data 10. For example, in this case, a feature extraction layer of a 3D CNN capable of feature extraction in consideration of time series can be used. Specifically, for example, by inputting the observation data and N frames before and after the observation data 10 to the 3D CNN, the feature value of the first input data 20 considering time series can be obtained from the feature extraction layer of the 3D CNN. In addition, data (a three-dimensional skeleton feature value, hereinafter) representing a three-dimensional position of each skeleton can be adopted as the skeleton feature value considering time series. For example, a method (for example, PoseFormer) of computing a three-dimensional skeleton feature value by using a two-dimensional skeleton feature value (data representing the two-dimensional position of each skeleton) extracted from each of a plurality of pieces of time-series image data can be used to compute the three-dimensional skeleton feature value. In a case of using this method, for example, the three-dimensional skeleton feature value for the observation data 10 can be obtained by applying the above-described method to the two-dimensional skeleton feature value computed from each of the observation data 10 and N frames before and after the observation data 10.

The process of generating the first input data 20 from the observation data 10 may be executed by the classification apparatus 2000 or may be executed by an apparatus other than the classification apparatus 2000. In a case where the first input data 20 is generated by the classification apparatus 2000, for example, the classification apparatus 2000 acquires the observation data 10, generates the first input data 20 from the observation data 10, and then stores the first input data 20 in a certain storage device. In this case, the acquisition unit 2020 acquires the first input data 20 from the storage device.

In a case where the first input data 20 is generated by an apparatus other than the classification apparatus 2000, for example, the first input data 20 is stored in advance in a certain storage device in a manner that the first input data 20 can be acquired from the classification apparatus 2000. In this case, the acquisition unit 2020 acquires the first input data 20 by reading the first input data 20 from this storage device. In another example, the acquisition unit 2020 acquires the first input data 20 by receiving the first input data 20 transmitted from another apparatus (for example, the apparatus that has generated the first input data 20).

### <Acquisition of Second Input Data 30: S102>

The acquisition unit 2020 acquires the second input data 30 (S102). Here, a method of generating the second input data 30 from the observation data 10 is similar to the method of generating the first input data 20 from the observation data 10. A concrete method of acquiring the second input data 30 is also similar to the specific method of acquiring the first input data 20.

As described above, the classification apparatus 2000 may use not only the first input data 20 and the second input data 30 but also three or more types of feature values. Also in this case, a method of generating the feature values and a method of acquiring the feature values are similar to the method of generating the first input data 20 and the method of acquiring the first input data 20.

### <Computation of Feature Value and Attention Data: S104 to S114>

Here, a method of computing the feature value and the attention data (that is, the first feature value 40, the second feature value 50, the first intermediate feature value 60, the second intermediate feature value 70, the second attention data 90, and the first attention data 80) will be described.

The first feature extraction unit 2040 and the second feature extraction unit 2060 computes feature values from the first input data 20 and the second input data 30 by performing dimensional compression on the first input data 20 and the second input data 30, respectively. For example, each of the first feature extraction unit 2040 and the second feature extraction unit 2060 has a feature extraction model for extracting a feature value by performing dimensional compression on input data. The feature extraction model includes a machine learning model such as a neural network. For example, a CNN can be used as the feature extraction model.

Here, the process executed on the first input data 20 and the second input data 30 may further include a process other than dimensional compression. For example, the CNN may include a pooling layer, a rectified linear unit (ReLU) layer, and the like in addition to a convolution layer in which a dimensional compression process is executed.

The attention generation unit 2080 also includes, for example, an attention generation model for generating attention data. The attention generation model includes a machine learning model such as a neural network.

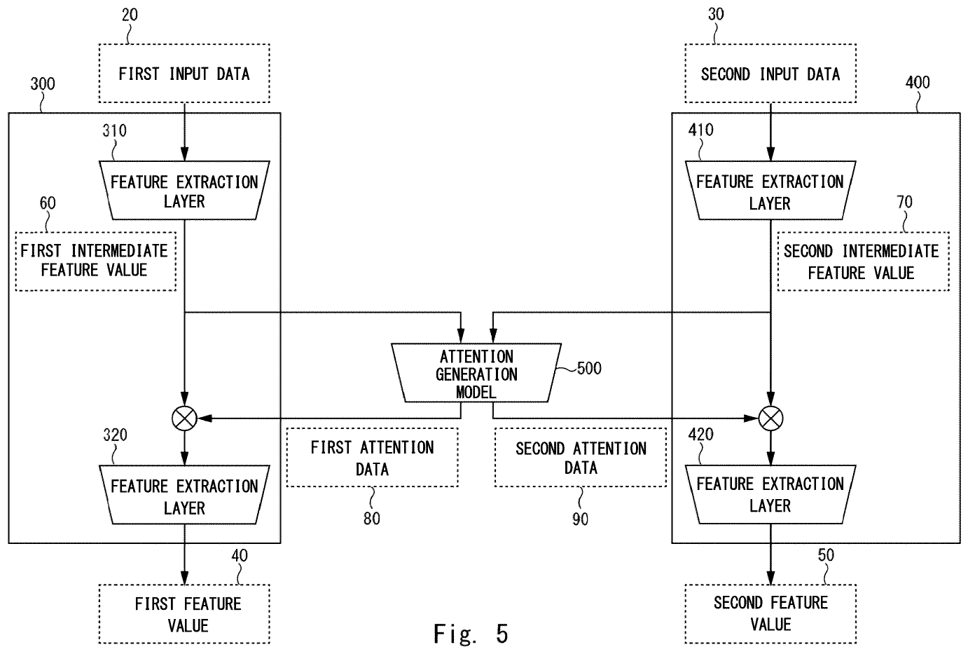

FIG. 5 is a diagram illustrating the feature extraction model and the attention model. A feature extraction model 300 and a feature extraction model 400 are models constituting the first feature extraction unit 2040 and the second feature extraction unit 2060, respectively. In addition, an attention generation model 500 is a model constituting the attention generation unit 2080.

The feature extraction model 300 includes a feature extraction layer 310 and a feature extraction layer 320. The feature extraction layer 310 acquires the first input data 20 as an input, and computes the first intermediate feature value 60 from the first input data 20. The feature extraction layer 320 acquires, as an input, data obtained by applying the first attention data 80 to the first intermediate feature value 60, and computes and outputs the first feature value 40 from the acquired data.

For example, each of the feature extraction layer 310 and the feature extraction layer 320 includes one or more layers including a layer (for example, a convolution layer) in which dimensional compression is performed on input data. In addition to the convolution layer, for example, a pooling layer, a ReLU layer, or the like can be included.

The first attention data 80 represents a weight (in other words, the degree of importance of each dimension) of the first intermediate feature value 60 for each dimension. Therefore, the number of dimensions of the first attention data 80 is the same as the number of dimensions of the first intermediate feature value 60. However, in a case where the first intermediate feature value 60 includes a plurality of channels, the number of dimensions of the first intermediate feature value 60 means the number of dimensions of one channel.

Various known methods can be used as a method of applying the attention data to the feature value. For example, the first feature extraction unit 2040 applies the first attention data 80 to the first intermediate feature value 60 by a method of multiplying the value of each element of the first intermediate feature value 60 by the value of the corresponding element of the first attention data 80. That is, a vector obtained by multiplying the value of each element of the first intermediate feature value 60 by the value of the corresponding element of the first attention data 80 is input to the feature extraction layer 320. Note that, in a case where the first intermediate feature value 60 includes a plurality of channels, the first attention data 80 is applied to each channel of the first intermediate feature value 60.

The feature extraction model 400 has a configuration similar to that of the feature extraction model 300. That is, the feature extraction model 400 includes a feature extraction layer 410 and a feature extraction layer 420. The feature extraction layer 410 acquires the second input data 30 as an input, and computes and outputs the second intermediate feature value 70 from the second input data 30. The feature extraction layer 420 acquires, as an input, data obtained by applying the second attention data 90 to the second intermediate feature value 70, and computes and outputs the second feature value 50 from the acquired data. Each of the feature extraction layer 410 and the feature extraction layer 420 may also include one or more layers including a dimensional compression layer.

The second attention data 90 represents a weight (the degree of importance of each dimension) of the second intermediate feature value 70 for each dimension. Therefore, the number of dimensions of the second attention data 90 is the same as the number of dimensions of the second intermediate feature value 70. However, in a case where the second intermediate feature value 70 includes a plurality of channels, the number of dimensions of the second intermediate feature value 70 means the number of dimensions of one channel.

As a method of applying the second attention data 90 to the second intermediate feature value 70, a method similar to the method of applying the first attention data 80 to the first intermediate feature value 60 can be used.

The attention generation model 500 acquires the first intermediate feature value 60 and the second intermediate feature value 70 as inputs, and computes and outputs the first attention data 80 and the second attention data 90. A configuration of the attention generation model 500 will be further described below.

For example, the attention generation model 500 computes the first attention data 80 by using the second intermediate feature value 70 not using the first intermediate feature value 60. Furthermore, the attention generation model 500 computes the second attention data 90 by using the first intermediate feature value 60 not using the second intermediate feature value 70.

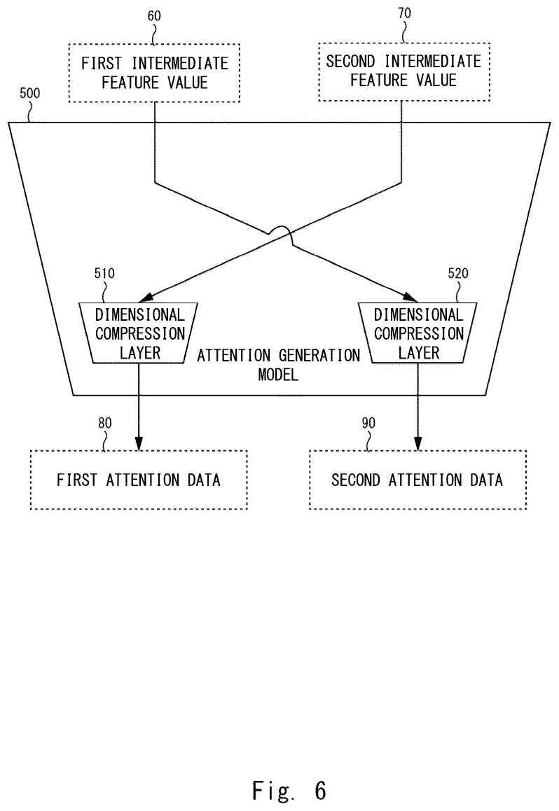

FIG. 6 is a first diagram illustrating the configuration of the attention generation model 500. In FIG. 6, the attention generation model 500 includes a dimensional compression layer 510 and a dimensional compression layer 520. The dimensional compression layer 510 generates the first attention data 80 by acquiring the second intermediate feature value 70 as an input, and performing dimensional compression on the second intermediate feature value 70. The dimensional compression layer 520 generates the second attention data 90 by acquiring the first intermediate feature value 60 as an input, and performing dimensional compression on the first intermediate feature value 60. For example, both the dimensional compression layer 510 and the dimensional compression layer 520 include one or more layers including a convolution layer.

Here, in the dimensional compression layer 510, the dimensional compression is performed such that the number of dimensions of the first attention data 80 is equal to the number of dimensions of the first intermediate feature value 60. Furthermore, in the dimensional compression layer 520, the dimensional compression is performed such that the number of dimensions of the second attention data 90 is equal to the number of dimensions of the second intermediate feature value 70.

Furthermore, the attention generation model 500 may execute a normalization process using a sigmoid function or the like on the output from the dimensional compression layer 510 or the dimensional compression layer 520.

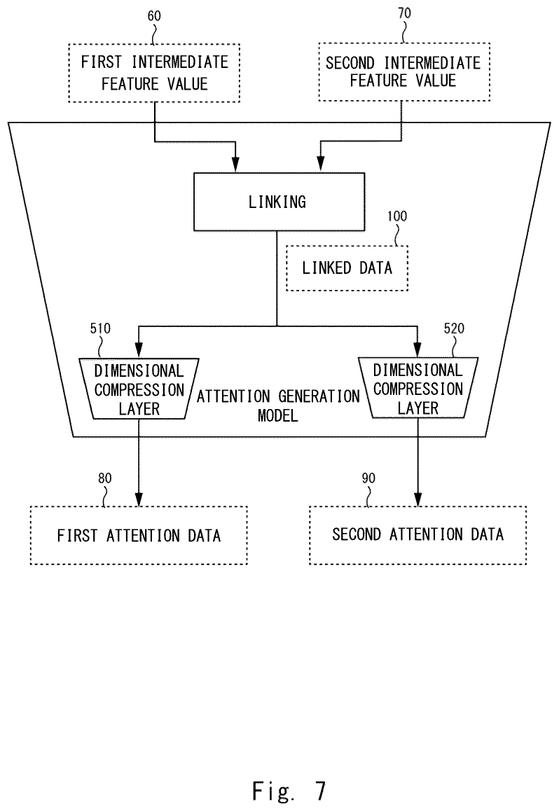

In another example, the attention generation model 500 uses the first intermediate feature value 60 and the second intermediate feature value 70 for both the computation of the first attention data 80 and the computation of the second attention data 90. FIG. 7 is a second diagram illustrating the configuration of the attention generation model 500. In FIG. 7, the attention generation model 500 computes the second attention data 90 and the first attention data 80 by computing link data 100 and performing dimensional compression on the link data 100. The link data 100 is obtained by linking the input first intermediate feature value 60 and second intermediate feature value 70.

The attention generation model 500 includes a dimensional compression layer 530 in which the first attention data 80 is computed by performing dimensional compression on the link data 100, and a dimensional compression layer 540 in which the second attention data 90 is computed by performing dimensional compression on the link data 100. In the dimensional compression layer 530, the dimensional compression is performed on the link data 100 such that the number of dimensions of the first attention data 80 is equal to the number of dimensions of the first intermediate feature value 60. Further, in the dimensional compression layer 520, the dimensional compression is performed on the link data 100 such that the number of dimensions of the second attention data 90 is equal to the number of dimensions of the second intermediate feature value 70. For example, both the dimensional compression layer 530 and the dimensional compression layer 540 include one or more layers including a convolution layer. In addition, the attention generation model 500 may perform a normalization process using a sigmoid function or the like on the output from the dimensional compression layer 530 or the dimensional compression layer 540.

«Case where Intermediate Feature value and Attention Data are Computed Plurality of Times»

In the classification apparatus 2000, the intermediate feature value and the attention data may be generated a plurality of times. In this case, the first feature extraction unit 2040 and the second feature extraction unit 2060 execute a process of further computing the intermediate feature value from the intermediate feature value and the attention data one or more times.

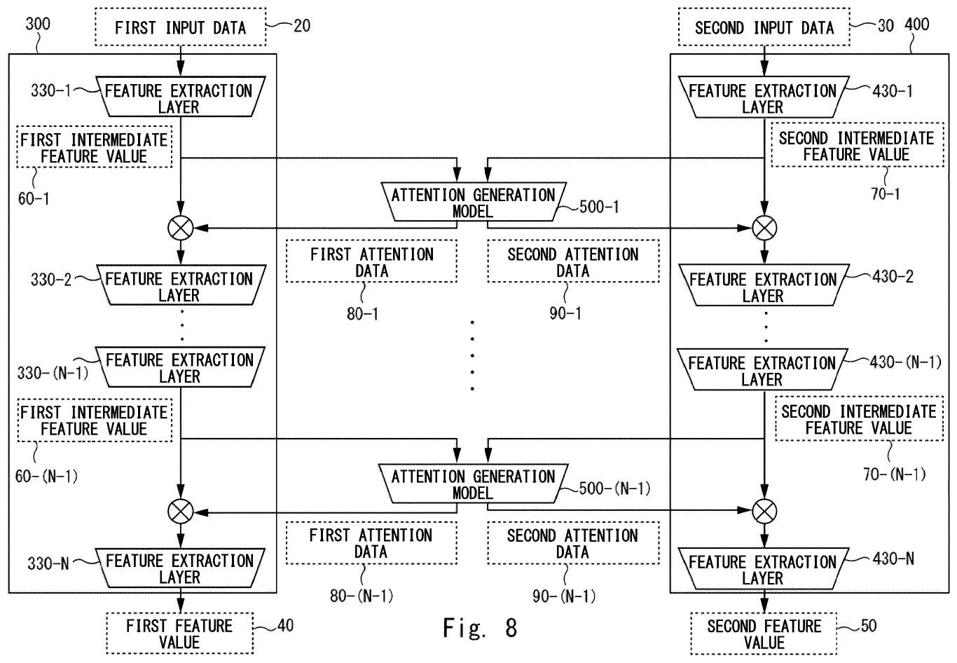

FIG. 8 is a diagram illustrating a case where the intermediate feature value and the attention data are generated a plurality of times. In this example, the feature extraction model 300 has N feature extraction layers of feature extraction layers 330-1 to 330-N. The feature extraction layer 330-1 corresponds to the feature extraction layer 310 in FIG. 5. On the other hand, a combination of the feature extraction layers 330-2 to 330-N corresponds to the feature extraction layer 320 in FIG. 5.

Similarly, the feature extraction model 400 has N feature extraction layers of feature extraction layers 430-1 to 430-N. The feature extraction layer 430-1 corresponds to the feature extraction layer 410 in FIG. 5. On the other hand, a combination of the feature extraction layers 430-2 to 430-N corresponds to the feature extraction layer 420 in FIG. 5.

The feature extraction layer 330-1 acquires the first input data 20 as an input, and outputs a first intermediate feature value 60-1. In addition, for 1<i<N, the feature extraction layer 330-i acquires data in which the first attention data 80-(i−1) is applied to the first intermediate feature value 60-(i−1) as an input, and outputs a first intermediate feature value 60-i. Further, the feature extraction layer 330-N acquires data in which the first attention data 80-(N−1) is applied to the first intermediate feature value 60-(N−1) as an input, and outputs the first feature value 40.

The feature extraction layer 430-1 acquires the second input data 30 as an input, and outputs a second intermediate feature value 70-1. In addition, for 1<i<N, the feature extraction layer 430-i acquires data in which the second attention data 90-(i−1) is applied to the second intermediate feature value 70-(i−1) as an input, and outputs a second intermediate feature value 70-i. Further, the feature extraction layer 430-N acquires data in which the second attention data 90-(N−1) is applied to the second intermediate feature value 70-(N−1) as an input, and outputs the second feature value 50.

In the example of FIG. 8, the classification apparatus 2000 is provided with (N−1) attention generation models of attention generation models 500-1 to 500-(N−1). The attention generation model 500-i acquires the first intermediate feature value 60-i and the second intermediate feature value 70-i as inputs, and outputs the first attention data 80-i and the second attention data 90-i. Here, i is any integer from 1 to N−1. An internal configuration of the attention generation model 500 is as described above.

### <Classification: S116>

The classification unit 2100 performs classification for the classification target by using the first feature value 40, the second feature value 50, or both thereof (S116). For example, the classification unit 2100 has a first classification model for estimating a class to which the first input data 20 belongs based on the first feature value 40 and a second classification model for estimating a class to which the second input data 30 belongs based on the second feature value 50. These classification models include, for example, a machine learning model such as a neural network.

More specifically, the first classification model acquires the first feature value 40 as an input, and outputs a first score vector representing the probability that the first input data 20 belongs to each of a plurality of predetermined classes using the second feature value 50. Therefore, it can be seen that one classifier is configured by a pair of the feature extraction model 300 and the first classification model.

Similarly, the second classification model acquires the second feature value 50 as an input, and outputs a second score vector representing the probability that the second input data 30 belongs to each of a plurality of predetermined classes using the second feature value 50. Therefore, it can be seen that one classifier is configured by a pair of the feature extraction model 400 and the second classification model.

For example, it is assumed that a person (worker) performing work is handled as a classification target, and the type of work performed by the worker is handled as a class. In addition, it is assumed that the first input data 20 and the second input data 30 are respectively an image feature value that is obtained from image data obtained by capturing the worker and a skeleton feature value of the worker that is extracted from the image data. Then, it is assumed that four types of works P1 to P4 are handled as types of work.

The classification unit 2100 obtains the first score vector by inputting the first feature value 40 computed from the image feature value (first input data 20) to the first classification model. The first score vector is a four-dimensional vector indicating the probability that the worker has performed the type of work for each of the work P1 to the work P4. Similarly, the classification unit 2100 obtains the second score vector by inputting the second feature value 50 computed from the skeleton feature value (second input data 30) to the second classification model. Similarly to the first score vector, the second score vector is also a four-dimensional vector indicating the probability that the worker has performed the type of work for each of the work P1 to the work P4.

The classification unit 2100 performs classification for the classification target by using the first score vector, the second score vector, or both thereof. In a case where only the first score vector is used for classification (in other words, in a case where only the first feature value 40 is used for classification), the classification unit 2100 determines a class corresponding to an element having the maximum value in the first score vector as a class regarding the classification target. For example, in the above-described example, it is assumed that the elements of the first score vector indicate the probabilities that the works P1 to P4 have been performed in this order. Then, it is assumed that the first score vector is (0.2, 0.1, 0.1, 0.6). In this case, since the value of the element corresponding to the work P4 is the maximum, the classification unit 2100 determines that the class (in this example, the type of work performed by the worker) regarding the classification target is the work P4.

In a case where only the second score vector is used for classification (in other words, in a case where only the second feature value 50 is used for classification), the classification unit 2100 determines the class corresponding to the element having the maximum value in the second score vector as the class regarding the classification target.

In a case where both the first score vector and the second score vector are used, the classification unit 2100 computes a vector obtained by integrating the first score vector and the second score vector by a predetermined method. Then, the classification unit 2100 determines the class corresponding to the element having the maximum value in the vector obtained by the integration as the class regarding the classification target.

Various methods can be used as a method of integrating a plurality of vectors representing scores into one. For example, the classification unit 2100 integrates the vectors by computing a weighted sum of the first score vector and the second score vector.

Here, in a case where the classification regarding the classification target is performed by using only the first score vector, the classification unit 2100 at the time of operation may be set not to compute the second score vector (that is, may be set such that the second classification model does not operate). In this case, the second score vector is used in training of a model which will be described later. Similarly, in a case where the classification regarding the classification target is performed by using only the second score vector, the classification unit 2100 at the time of operation may be set not to compute the first score vector.

### <Training of Models>

The feature extraction model 300, the feature extraction model 400, the attention generation model 500, the first classification model, and the second classification model described above are trained in advance by using training data so as to operate as models having the functions described above. A method of training these models will be exemplified below. Note that training of these models is also collectively referred to as “training of the classification apparatus 2000”. In addition, an apparatus that trains the classification apparatus 2000 is referred to as a “training apparatus”.

The training apparatus trains the classification apparatus 2000 by repeatedly updating parameters of each model included in the classification apparatus 2000 by using a plurality of pieces of training data. The training data includes the first input data 20 and the second input data 30 as input data, and includes information by which a class regarding a classification target can be identified as ground truth data. For example, the ground truth data is represented by a one-hot vector indicating 1 in an element corresponding to the class to which the classification target belongs and indicating 0 in elements corresponding to other classes.

The training apparatus inputs the first input data 20 and the second input data 30 included in the training data to the feature extraction model 300 and the feature extraction model 400, respectively. As a result, the first intermediate feature value 60 is computed by the feature extraction model 300, the second intermediate feature value 70 is computed by the feature extraction model 400, the first attention data 80 and the second attention data 90 are computed by the attention generation model 500, the first feature value 40 is computed by the feature extraction model 300, and the second feature value 50 is computed by the feature extraction model 400. Further, the first feature value 40 output from the feature extraction model 300 is input to the first classification model, and the first score vector is output. Similarly, the second feature value 50 output from the feature extraction model 400 is input to the second classification model, and the second score vector is output.

The training apparatus computes a loss by applying the first score vector, the second score vector, and the ground truth data to a predetermined loss function. Then, the training apparatus updates the parameter of each model (the feature extraction model 300, the feature extraction model 400, the attention generation model 500, the first classification model, and the second classification model) based on the computed loss. Note that various known methods can be used as a method of updating the parameters of the models based on the loss.

Various loss functions can be used. For example, the loss function is defined as a weighted sum of a first loss function representing the magnitude of a difference between the first score vector and the ground truth data and a second loss function representing the magnitude of a difference between the second score vector and the ground truth data. As the first loss function and the second loss function, for example, a function of computing cross entropy or the like can be used.

Note that, as described above, the classification unit 2100 may compute one integrated vector by integrating the first score vector and the second score vector. In this case, the training apparatus computes the loss by using a loss function representing a difference between the integrated vector and the ground truth data. Then, the parameters of the models are updated based on the computed loss. Note that, in a case where weights are assigned to the first score vector and the second score vector in integration, these weights can also be handled in the same manner as the parameters of the models. Therefore, the training apparatus also updates these weights by using the loss.

### <Output of Result>

The classification apparatus 2000 outputs an execution result. Information output from the classification apparatus 2000 is referred to as output information hereinafter. For example, the output information includes identification information of a class regarding the classification target, which is determined by the classification apparatus 2000. In addition, the output information may indicate information (the first score vector or the second score vector described above) indicating the probability that the classification target belongs to each class.

There may be various manners of outputting the output information. For example, the classification apparatus 2000 stores the output information in any storage device. In another example, the classification apparatus 2000 may transmit the output information to any apparatus.

### <Case Using Three or More Types of Data>

Here, a case where not only the first input data 20 and the second input data 30 but also other types of data are used by the classification apparatus 2000 will be described. Here, the number of types of data to be handled is denoted as M (M>2). In addition, the types of data are referred to as first data, second data, . . . , and M-th data, respectively.

The classification apparatus 2000 that handles M types of data computes M feature values of a first feature value to an M-th feature value from the M types of data of the first data to the M-th data, respectively. Therefore, the classification apparatus 2000 includes M feature extraction models of a first feature extraction model to an M-th feature extraction model, and M classification models of a first classification model to an M-th classification model.

An i-th feature extraction model acquires i-th data as an input, and computes an i-th intermediate feature value from the i-th data. Here, i is any integer from 1 to N. Further, the i-th feature extraction model computes an i-th feature value from data in which the i-th attention data is applied to the i-th intermediate feature value.

The attention generation model 500 generates the first attention data to the M-th attention data by using the first intermediate feature value to the M-th intermediate feature value. For example, the attention generation model 500 generates one piece of link data by linking all of the first intermediate feature value to the M-th intermediate feature value. Then, the respective M dimensional compression layers perform dimensional compression on the link data to generate the first attention data to the M-th attention data. Here, for each i, the dimensional compression is performed such that the number of dimensions of the i-th attention data is equal to the number of dimensions of the i-th intermediate feature value.

Here, each feature extraction model may perform the computation of the intermediate feature value twice or more as illustrated in FIG. 8. In other words, each feature extraction model may include three or more feature extraction layers. The operation of each attention generation model 500 in this case is similar to the case where there is one attention generation model 500.

The i-th classification model computes an i-th score vector by using the i-th feature value. The classification unit 2100 determines a class regarding the classification target by using one or more of the computed M score vectors. For example, the classification unit 2100 computes a weighted sum of the M score vectors and determines a class corresponding to an element having the maximum value in the computed vector as the class regarding the classification target. In another example, the classification unit 2100 may determine the class regarding the classification target by using one predetermined score vector. Note that, as described above, the score vector that is not used to determine the class at the time of operation does not need to be computed at the time of operation of the classification apparatus 2000. In this case, the classification models for computing these score vectors are used in the training of the model.

Although the present invention has been described above with reference to the example embodiment, the present invention is not limited to the above-described example embodiment. Various changes that can be understood by those skilled in the art can be made to the configuration and details of the present invention within the scope of the present invention.

In the above-described example, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Some or all of the above-described example embodiments may be described as in the following Supplementary Notes, but are not limited to the following Supplementary Notes.

### (Supplementary Note 1)

A classification apparatus comprising:
acquisition means for acquiring, for a classification target, first data being a first type of feature value and second data being a second type of feature value;
first feature extraction means for computing a first intermediate feature value from the first data, and then further computing a first feature value by using the first intermediate feature value;
second feature extraction means for computing a second intermediate feature value from the second data, and then further computing a second feature value by using the second intermediate feature value;
classification means for performing classification regarding the classification target by using the first feature value, the second feature value, or both thereof; and
attention data generation means for computing first attention data by using the second intermediate feature value and computing second attention data by using the first intermediate feature value,
wherein the first feature extraction means computes the first feature value by using the first intermediate feature value and the first attention data, and
wherein the second feature extraction means computes the second feature value by using the second intermediate feature value and the second attention data.

### (Supplementary Note 2)

The classification apparatus according to supplementary note 1,
wherein the attention data generation means:
generates the first attention data by performing dimensional compression on the second intermediate feature value to have the same number of dimensions as the number of dimensions of the first intermediate feature value; and
generates the second attention data by performing dimensional compression on the first intermediate feature value to have the same number of dimensions as the number of dimensions of the second intermediate feature value.

### (Supplementary Note 3)

The classification apparatus according to supplementary note 1,
wherein the attention data generation means:
generates link data obtained by linking the first intermediate feature value and the second intermediate feature value;
generates the first attention data by performing dimensional compression on the link data to have the same number of dimensions as the number of dimensions of the first intermediate feature value; and
generates the second attention data by performing dimensional compression on the link data to have the same number of dimensions as the number of dimensions of the second intermediate feature value.

### (Supplementary Note 4)

The classification apparatus according to supplementary note 3,
wherein the attention data generation means
generates the first attention data by executing a normalization process on the first intermediate feature value on which the dimensional compression has been performed; and
generates the second attention data by executing a normalization process on the second intermediate feature value on which the dimensional compression has been performed.

### (Supplementary Note 5)

The classification apparatus according to any one of supplementary notes 1 to 4,
wherein the first feature extraction means generates data in which a weight of each dimension represented by the first attention data is assigned to a value of each dimension of the first intermediate feature value and performs dimensional compression on the generated data, thereby computing the first feature value, and
wherein the second feature extraction means generates data in which a weight of each dimension represented by the second attention data is assigned to a value of each dimension of the second intermediate feature value and performs dimensional compression on the generated data, thereby computing the second feature value.

### (Supplementary Note 6)

The classification apparatus according to any one of supplementary notes 1 to 5,
wherein the first data is an image feature value extracted from image data obtained by capturing the classification target,
wherein the second data is a skeleton feature value extracted from the image data, and
wherein a class of the classification target represents a type of a motion of the classification target.

### (Supplementary Note 7)

A classification method executed by a computer, comprising:
an acquisition step for acquiring, for a classification target, first data being a first type of feature value and second data being a second type of feature value;
a first feature extraction step for computing a first intermediate feature value from the first data and then further computing a first feature value by using the first intermediate feature value;
a second feature extraction step for computing a second intermediate feature value from the second data and then further computing a second feature value by using the second intermediate feature value;
a classification step for performing classification regarding the classification target by using the first feature value, the second feature value, or both thereof; and
an attention data generation step for computing first attention data by using the second intermediate feature value and computing second attention data by using the first intermediate feature value,
wherein in the first feature extraction step, computing the first feature value by using the first intermediate feature value and the first attention data, and
wherein in the second feature extraction step, computing the second feature value by using the second intermediate feature value and the second attention data.

### (Supplementary Note 8)

The classification method according to supplementary note 7,
wherein in the attention data generation step:
generating the first attention data by performing dimensional compression on the second intermediate feature value to have the same number of dimensions as the number of dimensions of the first intermediate feature value; and
generating the second attention data by performing dimensional compression on the first intermediate feature value to have the same number of dimensions as the number of dimensions of the second intermediate feature value.

### (Supplementary Note 9)

The classification method according to supplementary note 7,
wherein in the attention data generation step:
generating link data by linking the first intermediate feature value and the second intermediate feature value;
generating the first attention data by performing dimensional compression on the link data to have the same number of dimensions as the number of dimensions of the first intermediate feature value; and
generating the second attention data by performing dimensional compression on the link data to have the same number of dimensions as the number of dimensions of the second intermediate feature value.

### (Supplementary Note 10)

The classification method according to supplementary note 9,
wherein in the attention data generation step:
generating the first attention data by executing a normalization process on the first intermediate feature value on which the dimensional compression has been performed; and
generating the second attention data by executing a normalization process on the second intermediate feature value on which the dimensional compression has been performed.

### (Supplementary Note 11)

The classification method according to any one of supplementary notes 7 to 10,
wherein in the first feature extraction step, generating data in which a weight of each dimension represented by the first attention data is assigned to a value of each dimension of the first intermediate feature value and performs dimensional compression on the generated data, thereby computing the first feature value, and
wherein in the second feature extraction step, generating data in which a weight of each dimension represented by the second attention data is assigned to a value of each dimension of the second intermediate feature value and performs dimensional compression on the generated data, thereby computing the second feature value.

### (Supplementary Note 12)

The classification method according to any one of supplementary notes 7 to 11,
wherein the first data is an image feature value extracted from image data obtained by capturing the classification target,
wherein the second data is a skeleton feature value extracted from the image data, and
wherein a class of the classification target represents a type of a motion of the classification target.

### (Supplementary Note 13)

A non-transitory computer-readable medium storing a program for causing a computer to execute:
an acquisition step for acquiring, for a classification target, first data being a first type of feature value and second data being a second type of feature value for a classification target;
a first feature extraction step for computing a first intermediate feature value from the first data and then further computing a first feature value by using the first intermediate feature value;
a second feature extraction step for computing a second intermediate feature value from the second data and then further computing a second feature value by using the second intermediate feature value;
a classification step for performing classification regarding the classification target by using the first feature value, the second feature value, or both thereof; and
an attention data generation step for computing first attention data by using the second intermediate feature value and computing second attention data by using the first intermediate feature value,
wherein in the first feature extraction step, computing the first feature value by using the first intermediate feature value and the first attention data, and
wherein in the second feature extraction step, computing the second feature value by using the second intermediate feature value and the second attention data.

### (Supplementary Note 14)

The computer-readable medium according to supplementary note 13,
wherein in the attention data generation step:
generating the first attention data by performing dimensional compression on the second intermediate feature value to have the same number of dimensions as the number of dimensions of the first intermediate feature value; and
generating the second attention data by performing dimensional compression on the first intermediate feature value to have the same number of dimensions as the number of dimensions of the second intermediate feature value.

### (Supplementary Note 15)

The computer-readable medium according to supplementary note 13,
wherein in the attention data generation step:
generating link data by linking the first intermediate feature value and the second intermediate feature value;
generating the first attention data by performing dimensional compression on the link data to have the same number of dimensions as the number of dimensions of the first intermediate feature value; and
generating the second attention data by performing dimensional compression on the link data to have the same number of dimensions as the number of dimensions of the second intermediate feature value.

### (Supplementary Note 16)

The computer-readable medium according to supplementary note 15,
wherein in the attention data generation step:
generating the first attention data by executing a normalization process on the first intermediate feature value on which the dimensional compression has been performed; and
generating the second attention data by executing a normalization process on the second intermediate feature value on which the dimensional compression has been performed.

### (Supplementary Note 17)

The computer-readable medium according to any one of supplementary notes 13 to 16,
wherein in the first feature extraction step, generating data in which a weight of each dimension represented by the first attention data is assigned to a value of each dimension of the first intermediate feature value and performs dimensional compression on the generated data, thereby computing the first feature value, and
wherein in the second feature extraction step, generating data in which a weight of each dimension represented by the second attention data is assigned to a value of each dimension of the second intermediate feature value and performs dimensional compression on the generated data, thereby computing the second feature value.

### (Supplementary Note 18)

The computer-readable medium according to any one of supplementary notes 13 to 17,
wherein the first data is an image feature value extracted from image data obtained by capturing the classification target,
wherein the second data is a skeleton feature value extracted from the image data, and
wherein a class of the classification target represents a type of a motion of the classification target.

### REFERENCE SIGNS LIST

10 OBSERVATION DATA
20 FIRST INPUT DATA
30 SECOND INPUT DATA
40 FIRST FEATURE VALUE
50 SECOND FEATURE VALUE
60 FIRST INTERMEDIATE FEATURE VALUE
70 SECOND INTERMEDIATE FEATURE VALUE
80 FIRST ATTENTION DATA
90 SECOND ATTENTION DATA
100 LINK DATA
300 FEATURE EXTRACTION MODEL
310 FEATURE EXTRACTION LAYER
320 FEATURE EXTRACTION LAYER
330 FEATURE EXTRACTION LAYER
400 FEATURE EXTRACTION MODEL
410 FEATURE EXTRACTION LAYER
420 FEATURE EXTRACTION LAYER
430 FEATURE EXTRACTION LAYER
500 ATTENTION GENERATION MODEL
510 DIMENSIONAL COMPRESSION LAYER
520 DIMENSIONAL COMPRESSION LAYER
530 DIMENSIONAL COMPRESSION LAYER
540 DIMENSIONAL COMPRESSION LAYER
1000 COMPUTER
1020 BUS
1040 PROCESSOR
1060 MEMORY
1080 STORAGE DEVICE
1100 INPUT/OUTPUT INTERFACE
1120 NETWORK INTERFACE
2000 CLASSIFICATION APPARATUS
2020 ACQUISITION UNIT
2040 FIRST FEATURE EXTRACTION UNIT
2060 SECOND FEATURE EXTRACTION UNIT
2080 ATTENTION GENERATION UNIT
2100 CLASSIFICATION UNIT

What is claimed is:

1. A classification apparatus comprising:
at least one memory that is configured to store instructions; and
at least one processor that is configured to execute the instructions to:
acquire, for a classification target, first data being a first type of feature value and second data being a second type of feature value;
compute a first intermediate feature value from the first data, and then further computing a first feature value by using the first intermediate feature value;
compute a second intermediate feature value from the second data, and then further computing a second feature value by using the second intermediate feature value;
perform classification regarding the classification target by using the first feature value, the second feature value, or both thereof; and
compute first attention data by using the second intermediate feature value and computing second attention data by using the first intermediate feature value,
wherein the first feature value is computed by using the first intermediate feature value and the first attention data, and
wherein the second feature value is computed by using the second intermediate feature value and the second attention data.

2. The classification apparatus according to claim 1,
wherein the computation of the first attention data includes performing dimensional compression on the second intermediate feature value to generate the first attention data having the same number of dimensions as the number of dimensions of the first intermediate feature value, and
wherein the computation of the second attention data includes performing dimensional compression on the first intermediate feature value to generate the second attention data having the same number of dimensions as the number of dimensions of the second intermediate feature value.

3. The classification apparatus according to claim 1,
wherein the computation of the first attention data and the second attention data includes:
generating link data obtained by linking the first intermediate feature value and the second intermediate feature value;
performing dimensional compression on the link data to generate the first attention data having the same number of dimensions as the number of dimensions of the first intermediate feature value; and
performing dimensional compression on the link data to generate the second attention data having the same number of dimensions as the number of dimensions of the second intermediate feature value.

4. The classification apparatus according to claim 3,
wherein the computation of the first attention data includes executing a normalization process on the first intermediate feature value on which the dimensional compression has been performed to generate the first attention data, and
wherein the computation of the second attention data includes executing a normalization process on the second intermediate feature value on which the dimensional compression has been performed to generate the second attention data.

5. The classification apparatus according to claim 1,
wherein the computation of the first feature value includes generating data in which a weight of each dimension represented by the first attention data is assigned to a value of each dimension of the first intermediate feature value and performs dimensional compression on the generated data, thereby computing the first feature value, and
wherein the computation of the second feature value includes generating data in which a weight of each dimension represented by the second attention data is assigned to a value of each dimension of the second intermediate feature value and performs dimensional compression on the generated data, thereby computing the second feature value.

6. The classification apparatus according to claim 1,
wherein the first data is an image feature value extracted from image data obtained by capturing the classification target,
wherein the second data is a skeleton feature value extracted from the image data, and
wherein a class of the classification target represents a type of a motion of the classification target.

7. A classification method executed by a computer, comprising:
acquiring, for a classification target, first data being a first type of feature value and second data being a second type of feature value,
computing a first intermediate feature value from the first data and then further computing a first feature value by using the first intermediate feature value;
computing a second intermediate feature value from the second data and then further computing a second feature value by using the second intermediate feature value;
performing classification regarding the classification target by using the first feature value, the second feature value, or both thereof; and
computing first attention data by using the second intermediate feature value and computing second attention data by using the first intermediate feature value,
wherein the first feature value is computed by using the first intermediate feature value and the first attention data, and
wherein the second feature value is computed by using the second intermediate feature value and the second attention data.

8. The classification method according to claim 7,
wherein the computation of the first attention data includes performing dimensional compression on the second intermediate feature value to generate the first attention data having the same number of dimensions as the number of dimensions of the first intermediate feature value, and
wherein the computation of the second attention data includes performing dimensional compression on the first intermediate feature value to generate the second attention data having the same number of dimensions as the number of dimensions of the second intermediate feature value.

9. The classification method according to claim 7,
wherein the computation of the first attention data and the second attention data includes:
generating link data by linking the first intermediate feature value and the second intermediate feature value;
performing dimensional compression on the link data to generate the first attention data having the same number of dimensions as the number of dimensions of the first intermediate feature value; and
performing dimensional compression on the link data to generate the second attention data having the same number of dimensions as the number of dimensions of the second intermediate feature value.

10. The classification method according to claim 9,
wherein the computation of the first attention data includes executing a normalization process on the first intermediate feature value on which the dimensional compression has been performed to generate the first attention data, and
wherein the computation of the second attention data includes executing a normalization process on the second intermediate feature value on which the dimensional compression has been performed to generate the second attention data.

11. The classification method according to claim 7,
wherein the computation of the first feature value includes generating data in which a weight of each dimension represented by the first attention data is assigned to a value of each dimension of the first intermediate feature value and performs dimensional compression on the generated data, thereby computing the first feature value, and
wherein the computation of the second feature value includes generating data in which a weight of each dimension represented by the second attention data is assigned to a value of each dimension of the second intermediate feature value and performs dimensional compression on the generated data, thereby computing the second feature value.

12. The classification method according to claim 7,
wherein the first data is an image feature value extracted from image data obtained by capturing the classification target,
wherein the second data is a skeleton feature value extracted from the image data, and
wherein a class of the classification target represents a type of a motion of the classification target.

13. A non-transitory computer-readable medium storing a program for causing a computer to execute:
acquiring, for a classification target, first data being a first type of feature value and second data being a second type of feature value for a classification target;
computing a first intermediate feature value from the first data and then further computing a first feature value by using the first intermediate feature value;
computing a second intermediate feature value from the second data and then further computing a second feature value by using the second intermediate feature value;
performing classification regarding the classification target by using the first feature value, the second feature value, or both thereof; and
computing first attention data by using the second intermediate feature value and computing second attention data by using the first intermediate feature value,
wherein the first feature value is computed by using the first intermediate feature value and the first attention data, and
wherein the second feature value is computed by using the second intermediate feature value and the second attention data.

14. The computer-readable medium according to claim 13,
wherein the computation of the first attention data includes performing dimensional compression on the second intermediate feature value to generate the first attention data having the same number of dimensions as the number of dimensions of the first intermediate feature value, and
wherein the computation of the second attention data includes performing dimensional compression on the first intermediate feature value to generate the second attention data having the same number of dimensions as the number of dimensions of the second intermediate feature value.

15. The computer-readable medium according to claim 13,
wherein the computation of the attention data and the second attention data includes:
generating link data by linking the first intermediate feature value and the second intermediate feature value,
performing dimensional compression on the link data to generate the first attention data having the same number of dimensions as the number of dimensions of the first intermediate feature value; and
performing dimensional compression on the link data to generate the second attention data having the same number of dimensions as the number of dimensions of the second intermediate feature value.

16. The computer-readable medium according to claim 15,
wherein the computation of the first attention data includes executing a normalization process on the first intermediate feature value on which the dimensional compression has been performed to generate the first attention data, and
wherein the computation of the second attention data includes executing a normalization process on the second intermediate feature value on which the dimensional compression has been performed to generate the second attention data.

17. The computer-readable medium according to claim 13,
wherein the computation of the first feature value includes generating data in which a weight of each dimension represented by the first attention data is assigned to a value of each dimension of the first intermediate feature value and performs dimensional compression on the generated data, thereby computing the first feature value, and
wherein the computation of the second feature value includes generating data in which a weight of each dimension represented by the second attention data is assigned to a value of each dimension of the second intermediate feature value and performs dimensional compression on the generated data, thereby computing the second feature value.

18. The computer-readable medium according to claim 13,
wherein the first data is an image feature value extracted from image data obtained by capturing the classification target,
wherein the second data is a skeleton feature value extracted from the image data, and
wherein a class of the classification target represents a type of a motion of the classification target.
